(19) United States
(12) Patent Application Publication
(10) Pub. No.: US 2024/0304916 A1
(43) Pub. Date: Sep. 12, 2024

(54) BATTERY PACK FOR POWER TOOL

(71) Applicant: MAKITA CORPORATION, Anjo-shi, Aichi (JP)

(72) Inventors: Kazuya TANAKA, Anjo-shi (JP); Tadahiko KOBAYAKAWA, Anjo-shi (JP)

(73) Assignee: MAKITA CORPORATION, Anjo-shi, Aichi (JP)

(21) Appl. No.: 18/279,501

(22) PCT Filed: Jan. 20, 2022
(86) PCT No.: PCT/JP2022/002020

§ 371 Date: Aug. 30, 2023

(30) Foreign Application Priority Data
Apr. 1, 2021 (JP) 2021-062918

(51) Int. Cl. H01M 50/211; H01M 50/291; H01M 50/296; H01M 50/507; H01M 50/51; H01M 50/519

(52) U.S. Cl. CPC H01M 50/211; H01M 50/291; H01M 50/296; H01M 50/507; H01M 50/51; H01M 50/519; H01M 2220/30

(57) ABSTRACT

A battery pack comprises a plurality of pouch battery cells stacked along a first direction; a main board located in the first direction relative to the plurality of pouch battery cells and including a power port for electrical connection to an external device; a sub board located in a second direction perpendicular to the first direction relative to the plurality of pouch battery cells and connected to positive electrode tabs and negative electrode tabs of the plurality of pouch battery cells; and a connection member electrically connecting the sub board to the main board.

### TECHNICAL FIELD

The disclosure herein relates to a battery pack for power tool.

### BACKGROUND ART

Japanese Patent Application Publication No. 2005-209367 describes a battery pack for power tool. In this battery pack, a plurality of prismatic battery cells is stacked along one direction.

### SUMMARY OF INVENTION

Pouch battery cells may be used in a battery pack for power tool. The pouch battery cells are also referred to as laminated battery cells due to their exteriors with laminate films. The pouch battery cells have a high energy density. Thus, using pouch battery cells in a battery pack allows for improved performance of the battery pack and a reduction in the weight of the battery pack. However, using pouch battery cells effectively in the battery pack for power tool requires a revision in the basic configuration of the battery pack, and there is a need for a useful technology for this purpose.

In view of the above, the present specification discloses a novel battery pack. This battery pack comprises a plurality of pouch battery cells stacked along a first direction, wherein each of the pouch battery cells comprises a positive electrode tab and a negative electrode tab that protrude in a second direction perpendicular to the first direction; a main board located in the first direction relative to the plurality of pouch battery cells and comprising a power port for electrical connection to an external device; a sub board located in the second direction relative to the plurality of pouch battery cells and connected to the positive electrode tabs and the negative electrode tabs of the plurality of pouch battery cells, and a connection member electrically connecting the sub board to the main board.

In the battery pack described above, the two boards, namely the main board and the sub board, are arranged perpendicular to each other around the plurality of stacked pouch battery cells. Each of the plurality of pouch battery cells is connected to the sub board, and the main board comprises the power port for electrical connection to the external device. The main board and the sub board are connected via the connection member, so that the plurality of pouch battery cells is electrically connected to the power port via the two boards. According to this configuration, it is possible to place more pouch battery cells and use larger pouch battery cells within a limited space in the battery pack.

### BRIEF DESCRIPTION OF DRAWINGS

FIG. 1 is a perspective view showing an exterior of a battery pack 10.

FIG. 2 is an exploded perspective view of the battery pack 10.

FIG. 3 is an exploded perspective view of a cell unit 30.

FIG. 4 is a front view of the cell unit 30.

FIG. 5 is a cross-sectional view along a line V-V in FIG. 4.

FIG. 6 is a cross-sectional view at the same position as that of FIG. 5, showing a modification of a lead plate 80x.

FIG. 7 is a perspective view showing a frame 50 and a sub board 70.

FIG. 8 is an enlarged view of a portion VIII in FIG. 7.

FIG. 9 is a perspective view showing a cell holder 40.

FIG. 10 shows a cooling air flow in the battery pack 10.

FIG. 11 shows an opposite cooling air flow in the battery pack 10.

FIG. 12 shows a modification of inner air inlet 34.

FIG. 13 shows a modification of a flow guide wall 38.

FIG. 14 shows a step of a manufacturing method of the battery pack 10.

FIG. 15 shows a step of the manufacturing method of the battery pack 10.

FIG. 16 shows a step of the manufacturing method of the battery pack 10.

FIG. 17 shows a step of the manufacturing method of the battery pack 10.

FIG. 18 is a perspective view showing a modification of a sub board 170.

### DETAILED DESCRIPTION

In an embodiment of the technology disclosed herein, the connection member may comprise at least one lead plate.

In an embodiment of the technology disclosed herein, the main board may intersect a straight line extending from the sub board in the first direction. In this case, the lead plate may extend parallel to the first direction between the sub board and the main board. According to this configuration, the main board and the sub board can be connected via the shortest path.

In an embodiment of the technology disclosed herein, the main board may not intersect a straight line extending from the sub board in the first direction. In this case, the lead plate may extend at an angle to the first direction between the sub board and the main board. According to this configuration, the main board and the sub board can be connected via a relatively short path.

In an embodiment of the technology disclosed herein, the battery pack may further comprise a cell holder holding the plurality of pouch battery cells. According to this configuration, the plurality of pouch battery cells can be stably held.

In an embodiment of the technology disclosed herein, the cell holder may comprise an inner surface facing the plurality of pouch battery cells. In this case, the inner surface of the cell holder may comprise a plurality of ribs supporting each of the plurality of pouch battery cells. According to this configuration, the plurality of pouch battery cells can be more stably held.

In the embodiment described above, the plurality of ribs may be located in an opposite direction to the second direction relative to the plurality of pouch battery cells. That is, the plurality of ribs may respectively support the plurality of pouch battery cells on the opposite side to the positive electrode tabs and the negative electrode tabs. According to this configuration, the plurality of pouch battery cells can be more stably held.

In the embodiment described above, the battery pack may further comprise a housing accommodating the cell holder, and a cushioning member located between the cell holder and the housing. According to this configuration, it is possible to suppress an impact and vibration externally applied to the housing from being transmitted to the battery cells.

In an embodiment of the technology disclosed herein, the main board may be attached to the cell holder. According to this configuration, the main board can be held together with the plurality of pouch battery cells in an integral manner.

In addition to or instead of the above, the sub board may be attached to the cell holder. According to this configuration, the sub board can be held together with the plurality of pouch battery cells in an integral manner.

In the embodiment described above, the sub board may be attached to the cell holder via a frame. In this case, the frame may cover at least a portion of a periphery of the sub board. According to this configuration, the sub board can be protected by the frame.

In the embodiment described above, the frame may comprise an inner surface facing the plurality of pouch battery cells. In this case, the inner surface of the frame may comprise a plurality of ribs supporting each of the plurality of pouch battery cells. According to this configuration, the plurality of pouch battery cells can be stably held.

In the embodiment described above, the frame may be removably attached to the cell holder. According to this configuration, assembly work for the battery pack can be facilitated depending on the configuration of battery pack. Alternatively, in another embodiment, a part or the entirety of the frame may be formed integrally with the cell holder.

In an embodiment of the technology disclosed herein, the sub board may comprise circuitry that electrically connects the plurality of pouch battery cells. According to this configuration, during manufacture of the battery pack, the pouch battery cells can be electrically connected by connecting the positive electrode tabs and the negative electrode tabs of the plurality of pouch battery cells to the sub board.

In the embodiment described above, the circuitry may connect the plurality of pouch battery cells in series. However, in another embodiment, the circuitry may connect a part or all of the plurality of pouch battery cells in parallel.

In the embodiment described above, the plurality of pouch battery cells may be stacked such that orientations of front and back sides of the pouch battery cells are reversed alternately. In each pair of adjacent two pouch battery cells, the positive electrode tab of one pouch battery cell may be adjacent to the negative electrode tab of other pouch battery cell along the first direction. According to this configuration, the circuitry connecting the plurality of pouch battery cells in series can be configured with relatively short paths.

In the embodiment described above, the circuitry of the sub board may comprise a first conductor line extending intermittently along the first direction and a second conductor line extending intermittently and parallel to the first conductor line. In this case, in each of the plurality of pouch battery cells, one of the positive tab and the negative tab may be connected to the first conductor line and other of the positive tab and the negative tab may be connected to the second conductor line. According to this configuration, circuitry patterns on the sub board can be simplified.

In an embodiment of the technology disclosed herein, the circuitry of the sub board may further comprise a third conductor line extending between the first conductor line and the second conductor line along the first direction. In this case, one of the first conductor line and the second conductor line may be connected to the connection member via the third conductor line. It is necessary to provide an interval corresponding to a distance between the positive electrode tabs and the negative electrode tabs of the pouch battery cells between the first conductor line and the second conductor line. By disposing the third conductor line in the interval between the first conductor line and the second conductor line, the size of the sub board can be reduced. Alternatively, the areas of the respective conductor lines on the sub board can be enlarged without increasing the size of the sub board to suppress a loss and heat generation due to energization.

In the embodiment described above, the third conductor line may electrically connect between the negative electrode tab of one of the plurality of pouch battery cells that is located farthest from the main substrate and the connection member. According to this configuration, the potential of the third conductor line is lowered, and thus electrical shorting in the battery pack and current leakage from the battery pack can be suppressed.

In an embodiment of the technology disclosed herein, the power port may comprise a contact-type external connection terminal constituted of a conductive material. Alternatively, in another embodiment, the power port may be a wireless power port, for example, including an electromagnetic induction coil. The specific configuration of the power port is not particularly limited.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved battery packs, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EMBODIMENTS

Referring to the drawings, a battery pack 10 of an embodiment is described. The battery pack 10 of the present embodiment is a battery pack for power tools, and can be suitably used particularly in handheld power tools. The handheld power tools herein mean, typically, power tools including a motor or other actuator. However, the battery pack 10 of the present embodiment may be also used for other electrically powered equipment, in addition to the power tools.

Here, in the drawings, a direction FR indicates a front direction of front-rear direction, and a direction RR indicates a rear direction of the front-rear direction and the opposite direction to the front direction. In the drawings, a direction LH indicates a left direction of left-right direction, and a direction RH indicates a right direction of the left-right direction and the opposite direction to the left direction. Then, in the drawings, a direction UP indicates an up direction of up-down direction, and a direction DW indicates a down direction of the up-down direction and the opposite direction to the up direction. It should be understood that the front-rear direction, left-right direction, and up-down direction herein are defined only for illustration purpose, and are not intended to limit orientations of the battery pack 10 during its use and manufacture.

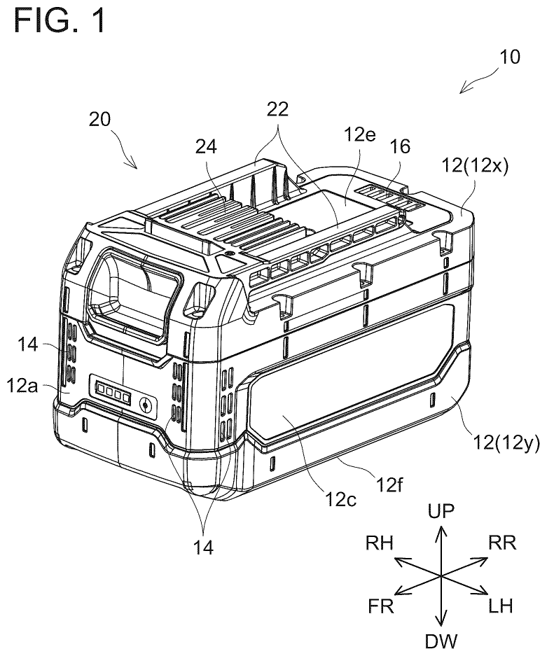

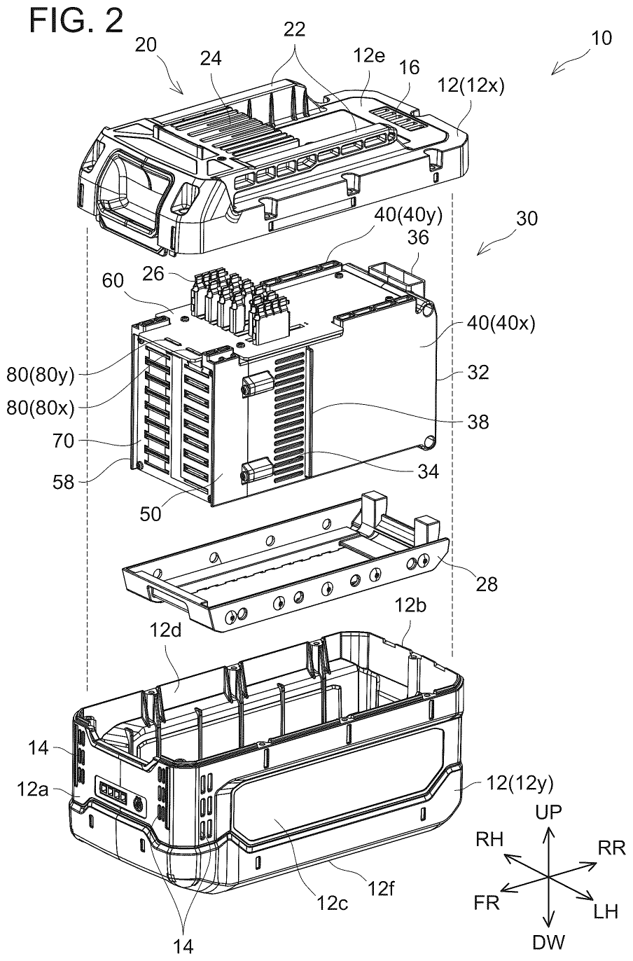

As shown in FIGS. 1 to 3, the battery pack 10 comprises a housing 12, a cell unit 30 accommodated inside the housing 12, and a cushioning member 28 located between the housing 12 and the cell unit 30. The cushioning member 28 is constituted of a rubber material. The housing 12 includes an upper part 12x and a lower part 12y. The housing 12 has a substantially cuboid shape and includes a front wall 12a, a rear wall 12b, a left wall 12c, a right wall 12d, an upper wall 12c, and a lower wall 12f. The upper wall 12e of the housing 12 includes a tool interface 20. The tool interface 20 is configured such that it can be physically and electrically attached to and removed from a power tool and a charger.

The tool interface 20 in the present embodiment comprises a pair of engagement rails 22 and an electric connector 24, although this is only an example. The pair of engagement rails 22 physically engages with a power tool or a charger to secure the battery pack 10 to the power tool or the charger. The electric connector 24 electrically connects to the power tool or the charger when the tool interface 20 is attached to the power tool or the charger. Thus, the battery pack 10 is electrically connected to the power tool or the charger. It should be understood that the position and configuration of the tool interface 20 are not particularly limited.

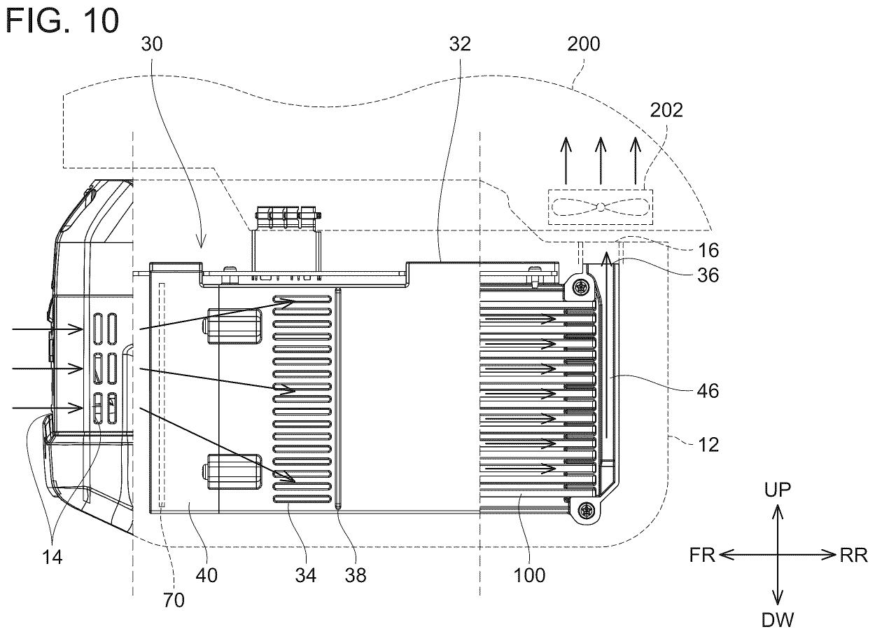

The housing 12 includes inlets 14 and an outlet 16. The inlets 14 are located in a front portion of the housing 12, and the outlet 16 is located in a rear portion of the housing 12. That is, the inlets 14 are located forward of the outlet 16. Thus, within the housing 12, cooling air flows in the rear direction of the front-rear direction. The inlets 14 in the present embodiment are defined in the front wall 12a, the left wall 12c, and the right wall 12d of the housing 12, and the outlet 16 is defined in the upper wall 12e of the housing 12, although this is only an example. When the battery pack 10 is attached to an external device 200 such as a power tool or a charger, the outlet 16 is connected to a fan 202 of the external device 200 (see FIG. 10), which will be described in detail later. Thus, the inside of the battery pack 10 is compellingly ventilated by the fan 202 of the external device 200.

The cell unit 30 comprises a plurality of pouch battery cells 100 and an inner housing 32 that accommodates the plurality of pouch battery cells 100. The pouch battery cells 100 are battery cells that accommodate positive and negative collector sheets and electrolyte within exteriors formed of laminate films. Each pouch battery cell 100 has a substantially flat shape, and the pouch battery cells 100 are stacked in the up direction (first direction). Each pouch battery cell 100 comprises a positive electrode tab 102 and a negative electrode tab 104. The positive electrode tab 102 and the negative electrode tab 104 are electrodes of the pouch battery cell 100 and are formed of sheets constituted of a conductive material such as a metal. In each pouch battery cell 100, the positive electrode tab 102 and the negative electrode tab 104 project in the front direction (second direction). The pouch battery cells 100 in the present embodiment are rechargeable secondary cattery cells and are particularly lithium-ion battery cells, although they are not particularly limited thereto. Hereinafter, the pouch battery cells 100 are referred to simply as battery cells 100.

The cell unit 30 comprises a cell holder 40, a frame 50, a main board 60, a sub board 70, and a connection member 80. The cell holder 40, the frame 50, the main board 60, and the sub board 70 are assembled to each other to form the inner housing 32 accommodating the plurality of pouch battery cells 100. The inner housing 32 includes inner inlets 34 and an inner outlet 36. The inner inlets 34 are located forward of the inner outlet 36. Thus, also within the inner housing 32, cooling air flows in the rear direction of the front-rear direction. The inner inlets 34 and the inner outlet 36 in the present embodiment are defined in the cell holder 40, although this is only an example. Specifically, the inner inlets 34 are located to face the plurality of pouch battery cells 100 in the left-right direction, and the inner outlet 36 is located rearward of the plurality of pouch battery cells 100.

The main board 60 is located in the front direction (first direction) relative to the plurality of battery cells 100. The main board 60 includes a power port 26. The power port 26 is located within the tool interface 20 and electrically connects to the external device 200 such as a power tool or a charger. The power port 26 in the present embodiment incudes a contact-type external connection terminal constituted of a conductive material, although this is only an example. Alternatively, the power port 26 may be a wireless power port, for example, including an electromagnetic induction coil. The main board 60 is secured to the cell holder 40 with a plurality of screws 61.

The sub board 70 is located in the front direction (second direction) relative to the plurality of battery cells 100. The positive electrode tabs 102 and the negative electrode tabs 104 of the battery cells 100 are connected to the sub board 70. Thus, the battery cells 100 are electrically connected to each other via the sub board 70. The sub board 70 in the present embodiment is configured such that it connects the battery cells 100 in series, which will be described in detail later. However, in another embodiment, the sub board 70 may be configured such that it connects a part or all of the battery cells 100 in parallel. The sub board 70 is secured to the frame 50 with a plurality of screws 71 and is removably attached to the cell holder 40 via the frame 50. The frame 50 is secured to the cell holder 40 with a plurality of screws 51, although this is only an example.

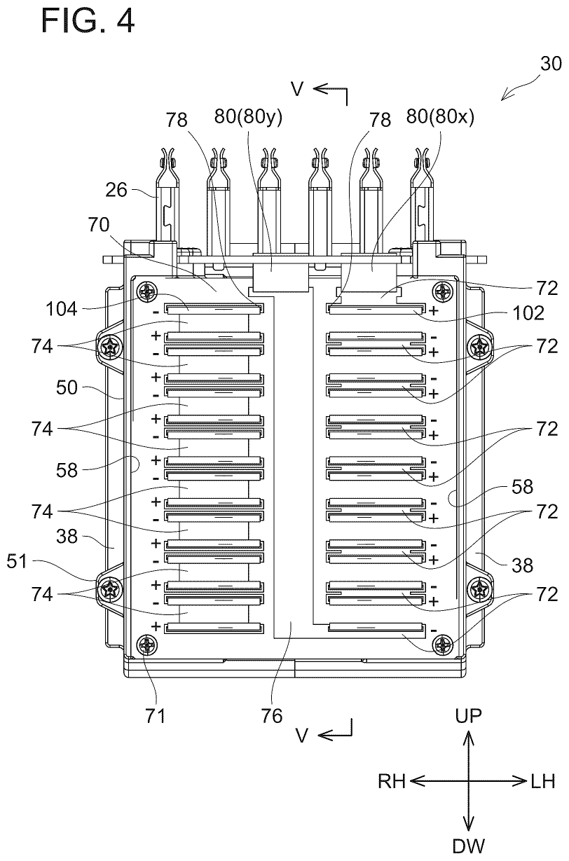

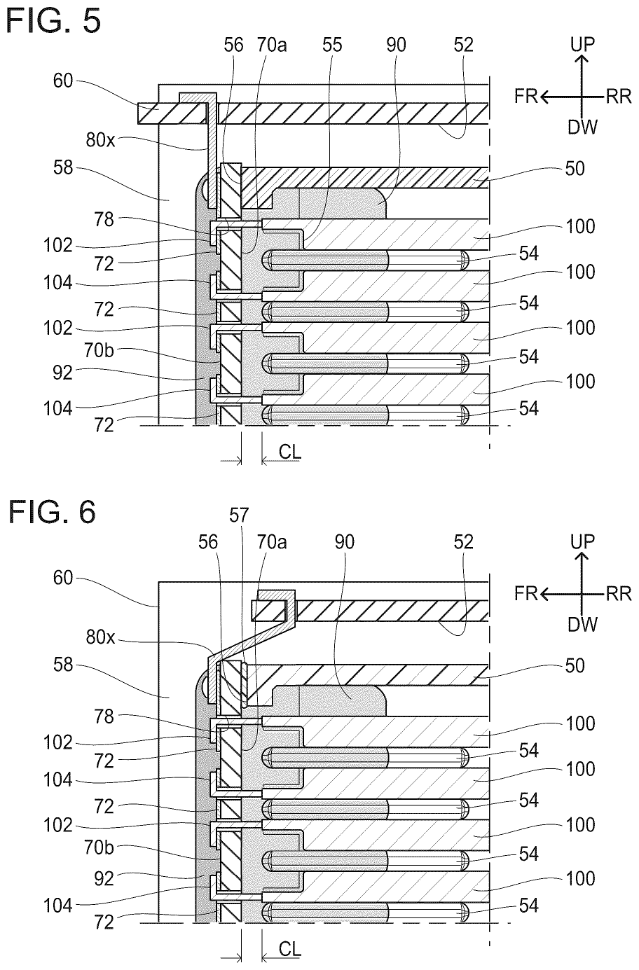

As shown in FIGS. 4 and 5, the connection member 80 extends between the sub board 70 and the main board 60, and electrically connects the sub board 70 to the main board 60. Thus, the plurality of battery cells 100 is electrically connected to the power port 26 via the sub board 70 and the min board 60. The connection member 80 includes a pair of lead plates 80x. 80y, although this is only an example. The pair of lead plates 80x, 80y includes a positive electrode lead plate 80x and a negative electrode lead plate 80y. Each of the lead plates 80x, 80y is constituted of a conductive material such as a metal. The main board 60 extends to above the sub board 70 and intersects a straight line that extends from the sub board 70 in the up direction (first direction). Thus, the lead plates 80x, 80y each extend parallel to the up direction (first direction) between the sub board 70 and the main board 60. According to this configuration, the main board 60 and the sub board 70 can be connected via the shortest path.

As shown in FIG. 6, however, in another embodiment, the main board 60 may not extend to above the sub board 70 and may not intersect the straight line extending from the sub board 70 in the first direction (up direction). In this case, the lead plates 80x, 80y may extend at an angle to the up direction (first direction) between the sub board 70 and the main board 60. According to this configuration, the main board 60 and the sub board 70 can be connected via a relatively short path. Here, the angle between the lead plates 80x, 80y and the up direction (first direction) is not particularly limited. The lead plates 80x, 80y may extend linearly or in a curved manner between the sub board 70 and the main board 60.

As shown in FIGS. 4 to 6, the sub board 70 includes a plurality of tab connection holes 78. In each of the plurality of tab connection holes 78, the positive electrode tab 102 or the negative electrode tab 104 of corresponding one of the plurality of battery cells 100 is inserted. Here, the sub board 70 includes a rear surface 70a facing the plurality of battery cells 100 and a front surface 70b opposite to the rear surface 70a. Then, the positive electrode tabs 102 and the negative electrode tabs 104 of the battery cells 100 are each joined to the sub board 70 on the front surface 70b of the sub board 70. Specifically, the positive electrode tabs 102 and the negative electrode tabs 104 are each welded to the front surface 70b of the sub board 70.

The pouch battery cells 100 are stacked such that orientations of the front and back sides of the pouch battery cells are reversed alternately, although they are not particularly limited thereto. Thus, in each pair of adjacent battery cells 100, the positive electrode tab 102 of one pouch battery cell 100 is adjacent to the negative electrode tab 104 of the other battery cell 100 in the up-down direction (i.e., in the first direction). According to this configuration, circuitry that connects the battery cells 100 in series can be simply formed on the sub board 70. In other words, the arrangement of the battery cells 100 and their individual orientations can be appropriately designed depending on the circuitry to be formed on the sub board 70.

The sub board 70 in the present embodiment incudes a first conductor line 72 extending intermittently along the up direction, a second conductor line 74 extending intermittently and parallel to the first conductor line 72, and a third conductor line 76 extending along the up direction between the first conductor line 72 and the second conductor line 74. The plurality of tab connection holes 78 as described above is arranged on each of the first conductor line 72 and the second conductor line 74, and the positive electrode tab 102 or the negative electrode tab 104 of each battery cell 100 is joined thereto. An upper end of the first conductor line 72 is connected to the positive electrode lead plate 80x, and a lower end of the second conductor line 74 is connected to the negative electrode lead plate 80y via the third conductor line 76. On the front surface 70b of the sub board 70, the positive electrode tabs 102 and the negative electrode tabs 104 of the battery cells 100 are covered with an adhesive 92. The adhesive 92 also covers the first conductor line 72, the second conductor line 74, and the third conductor line 76, in addition to the positive electrode tabs 102 and the negative electrode tabs 104.

According to the configuration above, the battery cells 100 are electrically connected in series between the positive electrode lead plate 80x and the negative electrode lead plate 80y. The positive electrode tab 102 of the uppermost battery cell 100 that is located closest to the main board 60 is connected to the positive electrode lead plate 80x via the first conductor line 72. On the other hand, the negative electrode tab 104 of the battery cell 100 that is located farthest from the main board 60 is connected to the negative electrode lead plate 80y via the third conductor line 76.

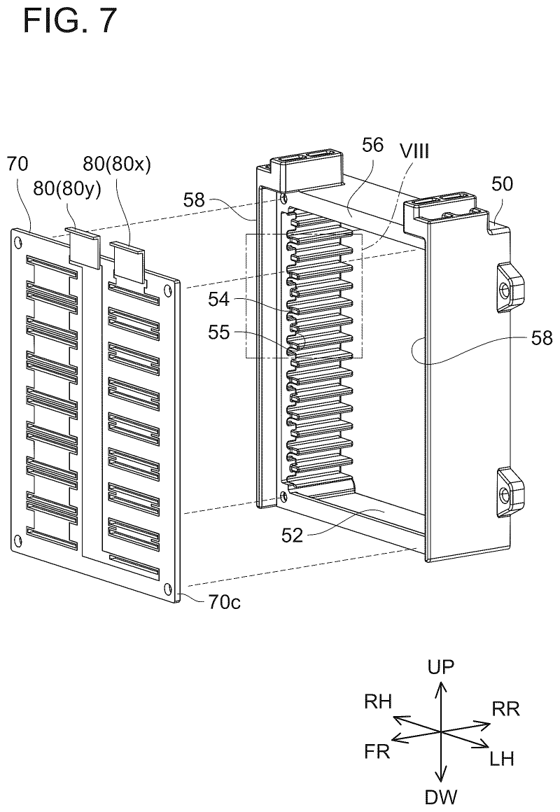

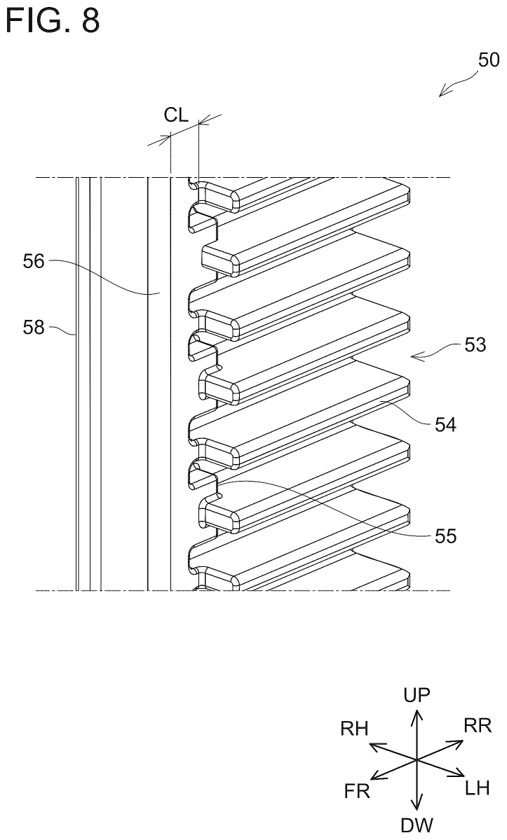

Referring to FIGS. 5 to 8, a configuration of the frame 50 is described. The frame 50 is constituted of a polymer material such as a resin. However, the material of the frame 50 is not particularly limited. As described above, the sub board 70 is attached to the frame 50. The frame 50 has a shape that extends around the plurality of battery cells 100 along the sub board 70. The area surrounded by the frame 50 is filled with a sealant 90. The sealant 90 encloses the positive electrode tabs 102 and the negative electrode tabs 104 extending from the battery cells 100 to the sub board 70. Thus, the positive electrode tabs 102 and the negative electrode tabs 104 as well as the sub board 70 to which the tabs are connected is protected from foreign matters and moisture from the outside, and the occurrence of electrical shorting within the battery pack 10 can be suppressed. Here, the sealant 90 may be constituted of a potting material or a photocurable material. For example, an ultraviolet curable resin is an example of the photocurable material.

The frame 50 includes a frame surface 56 that contacts the sub board 70. The frame surface 56 is oriented forward to face the sub board 70 and extends annularly along a periphery 70c of the sub board 70. According to this configuration, the sub board 70 is stably supported by the frame 50. Further, during the manufacture of the battery pack 10, leakage of pre-cured sealant 90 from a space between the sub board 70 and the frame 50 can be suppressed. Here, as shown in FIG. 6, a sheet material 57 that is more flexible than the frame 50 and the sub board 70 may be interposed between the frame surface 56 of the frame 50 and the sub board 70.

The frame 50 includes an inner surface 52 that faces the plurality of battery cells 100. The inner surface 52 extends annularly to surround the plurality of battery cells 100. The inner surface 52 of the frame 50 includes a plurality of ribs 54. The ribs 54 are arranged along the up-down direction and each extend in the front-rear direction. The ribs 54 support the battery cells 100. That is, each battery cell 100 is inserted between a corresponding pair of adjacent ribs 54. According to this configuration, during the manufacture of the battery pack 10, the battery cells 100 are stably supported by the frame 50 even before the sealant 90 cures.

There is a clearance CL between the respective ribs 54 and the sub board 70. In other words, there is the clearance CL between the respective ribs 54 and the frame surface 56. The respective ribs 54 being spaced apart from the sub board 70 allows pre-cured sealant 90 to flow over a broad area without being disrupted by the ribs 54 during the manufacture of the battery pack 10. It should be understood that the clearance CL between the ribs 54 and the sub board 70 can be also regarded as notches in the ribs 54. These notches may be provided in intermediate portions of the ribs 54 in its longitudinal direction instead of end portions of the ribs 54. According to this configuration as well, pre-cured sealant 90 can flow over a broad area through the notches.

The frame 50 includes a projection 55 between each pair of adjacent ribs 54. The projections 55 each contact corresponding one of the battery cells 100 and support the battery cells 100 from the front. The specific structure of the projections 55 is not particularly limited. The projections 55 may have any structure as long as they contact the battery cells 100 from the front, for example, they may project rearward from a surface opposite to the frame surface 56 or project upward or downward from side surfaces of the ribs 54.

The frame 50 includes rims 58 that project forward. The rims 58 are located at the left and right sides of the frame 50. The rims 58 extend in the up-down direction along the periphery 70c of the sub board 70 and cover the periphery 70c of the sub board 70. According to this configuration, the sub board 70 is protected by the frame 50. Further, when the sub board 70 is attached to the frame 50, the rims 58 can be used as guides for positioning the sub board 70 with respect to the frame 50.

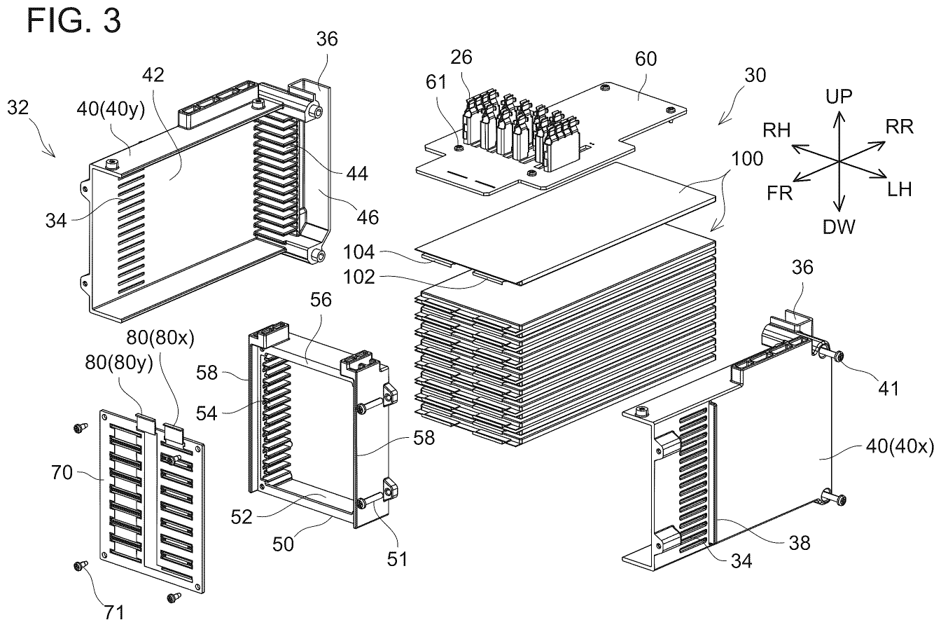

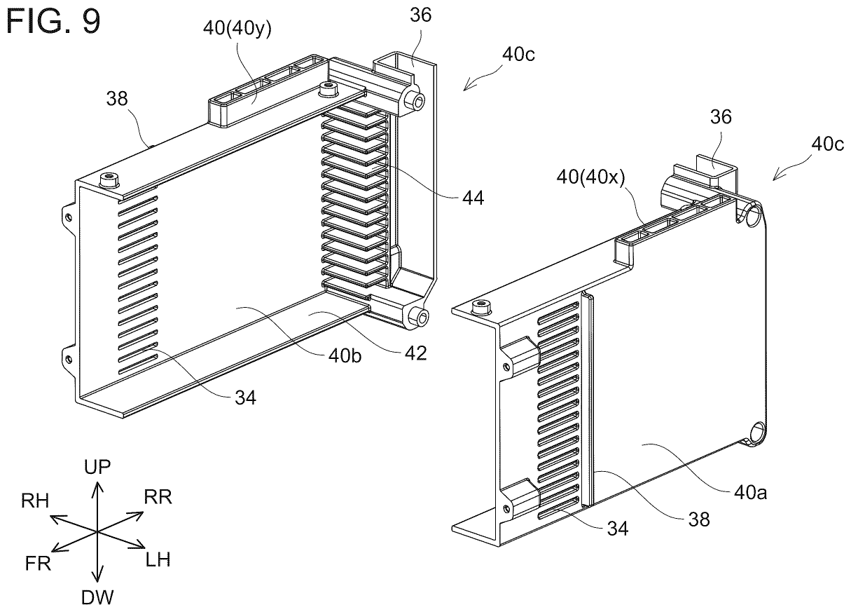

As shown in FIGS. 3 and 9, the cell holder 40 holds the plurality of battery cells 100 within the housing 12. The cell holder 40 includes an inner surface 42 that faces the plurality of battery cells 100. The inner surface 42 of the cell holder 40 includes a plurality of ribs 44. In the cell holder 40 of the present embodiment, the plurality of ribs 44 is located rearward of the plurality of battery cells 100, although they are not particularly limited thereto. That is, they are located opposite to the sub board 70, the positive electrode tabs 102, and the negative electrode tabs 104 with respect to the plurality of battery cells 100. The ribs 44 are arranged along the up-down direction and each extend in the left-right direction. The ribs 44 support the battery cells 100. That is, each battery cell 100 is inserted between a corresponding pair of adjacent ribs 44.

The cell holder 40 includes a left part 40x and a right part 40y, and accommodates the plurality of battery cells 100 between the left part 40x and the right part 40y. The left part 40x constitutes a left wall 40a of the cell holder 40 and a portion of a rear wall 40c of the cell holder 40. The right part 40y constitutes a right wall 40b of the cell holder 40 and another portion of the rear wall 40c of the cell holder 40. The ribs 44 described above are located on the rear wall 40c of the cell holder and are provided on each of the left part 40x and the right part 40y. As described above, the cell holder 40 constitutes, together with the main board 60 and the sub board 70, the inner housing 32 that accommodates the plurality of battery cells 100. Specifically, the main board 60 constitutes at least a portion of an upper wall of the inner housing 32, and the sub board 70 constitutes at least a portion of a front wall of the inner housing 32. Constituting at least a portion of the inner housing 32 with one or more of the boards 60, 70 allows for a saving of space for placing these boards 60, 70 and a reduction in the weigh of the inner housing 32.

The left wall 40a and the right wall 40b of the cell holder 40 constitute side walls of the inner housing 32. In the present specification, the side walls of the inner housing 32 may be referred to as inner side walls to distinguish them from the side walls 12c. 12d of the housing 12. The side walls 40a, 40b of the cell holder 40 (i.e., inner side walls) face the plurality of battery cells 100 in the left direction or the right direction (third direction) perpendicular to the up direction (first direction) and the front direction (second direction). The inner inlets 34 as described above are defined in the side walls 40a, 40b of the cell holder 40. The inner inlets 34 include a plurality of through holes defined in the side walls 40a, 40b of the cell holder 40. The through holes of the inner inlets 34 are arranged along the up direction (first direction) and are elongated along the front direction (second direction).

Flow guide walls 38 are disposed on the side walls 40a, 40b of the cell holder 40. The flow guide walls 38 are located between the side walls 40a, 40b of the cell holder 40 and the side walls 12c, 12d of the housing 12 facing the side walls 40a, 40b of the cell holder 40. The flow guide walls 38 project toward the side walls 12c. 12d of the housing 12. The inner inlets 34 are located forward of the flow guide walls 38. According to this configuration, cooling air taken into the housing 12 through the inlets 14 can be smoothly guided into the inner housing 32 through the inner inlets 34.

Meanwhile, the inner outlet 36 as described above is disposed at the rear wall 40c of the cell holder 40. The inner outlet 36 is located at an upper end of the rear wall 40c and opens upward. An outlet passage 46 connected to the inner outlet 36 is also disposed at the rear wall 40c. The outlet passage 46 is located rearward of the plurality of battery cells 100 and extends in the up-down direction.

Referring to FIG. 10, a cooling air flow in the battery pack 10 is described. In FIG. 10, the cooling air flow is schematically indicated with arrows. As described above, when the battery pack 10 is attached to the external device 200 such as a power tool or a charger, the outlet 16 of the housing 12 is connected to the fan 202 of the external device 200. Here, the inner outlet 36 of the inner housing 32 is located within the outlet 16 of the housing 12 and is connected to the outlet 16 substantially in an air tight manner. The fan 202 delivers air in a direction away from the battery pack 10 to suction air from the inside of the battery pack 10.

When the fan 202 operates, external air is taken into the housing 12 through the inlets 14. Within the housing 12, the cooling air flows rearward. At this time, the sub board 70 is also effectively cooled by the cooling air since the inlets 14 are located forward of the sub board 70. The cooling air within the housing 12 is taken into the inner housing 32 through the inner inlets 34. Since the inner inlets 34 includes the plurality of through holes arranged along the up-down direction, the cooling air is evenly distributed to the battery cells 100 stacked in the up-down direction. Within the inner housing 32, the cooling air flows rearward and then flows to the outside through the inner outlet 36 and the outlet 16. Since the inner outlet 36 and the outlet 16 are located rearward of the plurality of battery cells 100, the cooling air completely flows through the plurality of battery cells 100 before flowing to the outside.

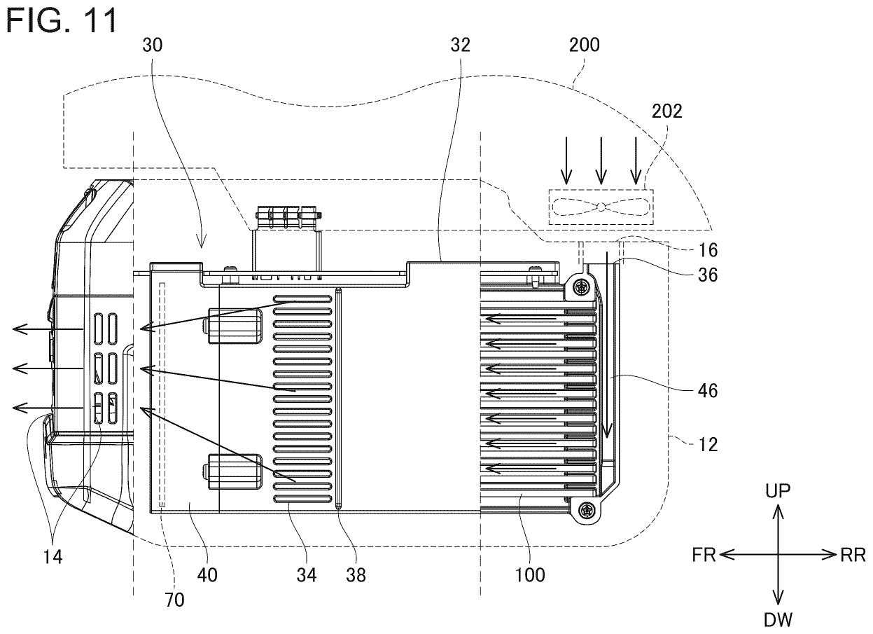

As shown in FIG. 11, the fan 202 of the external device 200 may deliver air toward the battery pack 10. In this case, the inlets 14 and the outlet 16 of the housing 12 function as outlets and an inlet of the housing 12, respectively. Similarly, the inner inlets 34 and the inner outlet 36 of the inner housing 32 function as inner outlets and an inner inlet of the inner housing 32, respectively. In this case, the inner inlet (36) is located within the inlet (16) and is connected to the inlet (16) substantially in an air tight manner. The inner inlet (36) and the inlet (16) are located rearward of the plurality of battery cells 100, and the cooling air flows forward within the housing 12 and the inner housing 32. The outlets (14) of the housing 12 are located forward of the inner outlets (34) of the inner housing 32 and are further located forward of the plurality of battery cells 100. The inner outlets (34) are located in the side walls 40a, 40b of the cell holder 40 and include a plurality of through holes arranged along the up-down direction. Then, each of the through holes is an elongated along the front-rear direction.

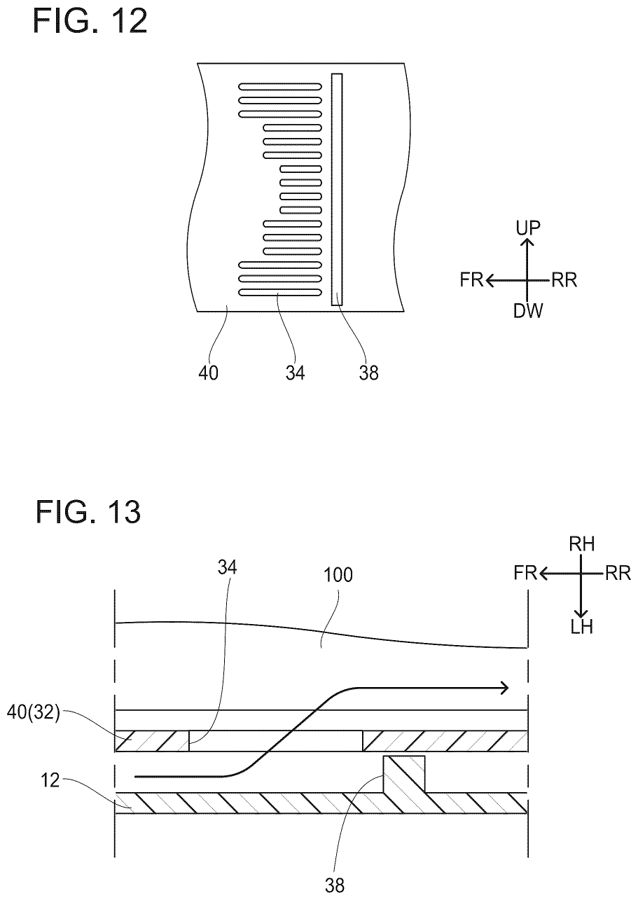

FIG. 12 shows a modification of the inner inlets 34. As shown in FIG. 12, a part or all of the through holes of the inner inlets 34 may have different sizes from each other. In this case, a part or all of the through holes may have different dimensions in the front-rear direction from each other, although this is only an example. On the other hand, distances between each of the through holes and the flow guide wall 38 may be equal to each other. In another embodiment, a part or all of the through holes of the inner inlets 34 may have different dimensions in the front-rear direction.

FIG. 13 shows a modification of the flow guide wall 38. As shown in FIG. 13, the flow guide wall 38 may be located on the housing 12 instead of or in addition to being located on the cell holder 40. In this case, the flow guide wall 38 may project from the housing 12 toward the cell holder 40, that is, toward the inner housing 32. According to this configuration as well, cooling air taken into the housing 12 can be smoothly guider into the inner housing 32 through the inner inlets 34.

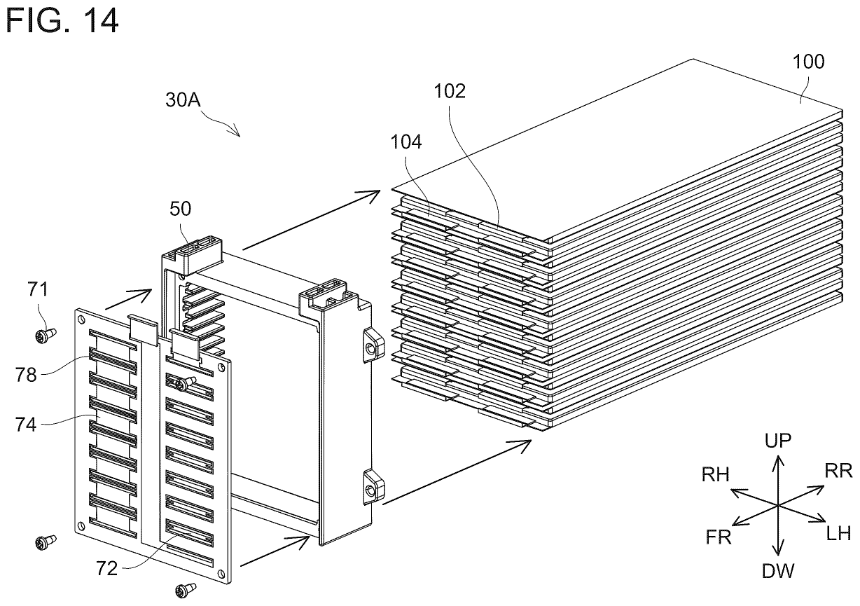

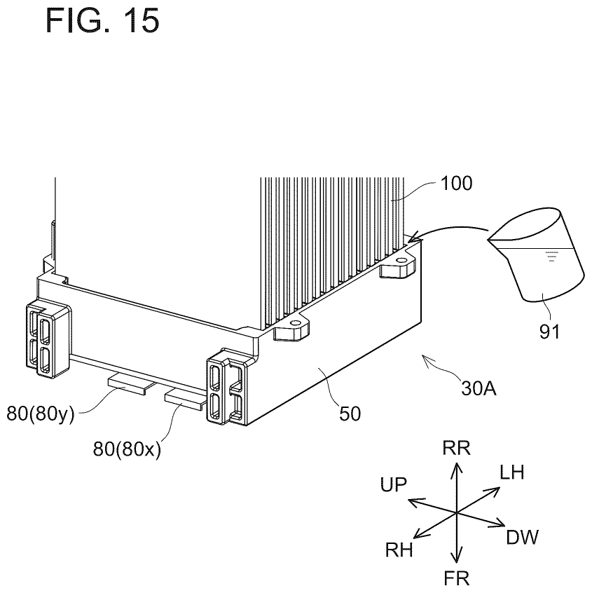

Next, referring to FIGS. 14 to 16, a manufacturing method for the battery pack 10 is described. First, as shown in FIG. 14, the frame 50, the sub board 70, and the plurality of battery cells 100 are assembled to each other to prepare a semi-manufactured component 30A of the cell unit 30. In this semi-manufactured component 30A, the battery cells 100 are stacked along the up direction (first direction). Further, each battery cell 100 includes the positive electrode tab 102 and the negative electrode tab 104 projecting forward. The battery cells 100 are stacked such that orientations of the front and back sides of the battery cells are reversed alternately. Thus, in each pair of adjacent battery cells 100, the positive electrode tab 102 of one battery cell 100 is adjacent to the negative electrode tab 104 of the other battery cell 100 in the up-down direction.

The positive electrode tabs 102 and the negative electrode tabs 104 of the battery cells 100 are electrically connected to the sub board 70. As described above, the plurality of tab connection holes 78 is defined in the sub board 70. The positive electrode tabs 102 and the negative electrode tabs 104 of the battery cells 100 are inserted into the tab connection holes 78. Then, the positive electrode tabs 102 and the negative electrode tabs 104 inserted in the tab connection holes 78 are each joined to the front surface 70b of the sub board 70. Specifically, the positive electrode tabs 102 and the negative electrode tabs 104 are each joined to the first conductor line 72 or the second conductor line 74 on the front surface 70b of the sub board 70. The frame 50 extends around the plurality of battery cells 100 along the sub board 70.

Next, as shown in FIG. 15, the semi-manufactured component 30A is oriented such that the area surrounded by the frame 50 is positioned above the sub board 70. Then, the area surrounded by the frame 50 is filled with a mobile material 91. This material 91 is a material constituting the sealant 90 and may be, for example, a pre-cured potting material or photocurable material. Thereafter, the mobile material 91 is cured, so that the sealant 90 that encloses the positive electrode tabs 102 and the negative electrode tabs 104 extending from the battery cells 100 to the sub board 70 is formed. By using the frame 50 and the sub board 70 as a mold in this way, the sealant 90 can be easily formed.

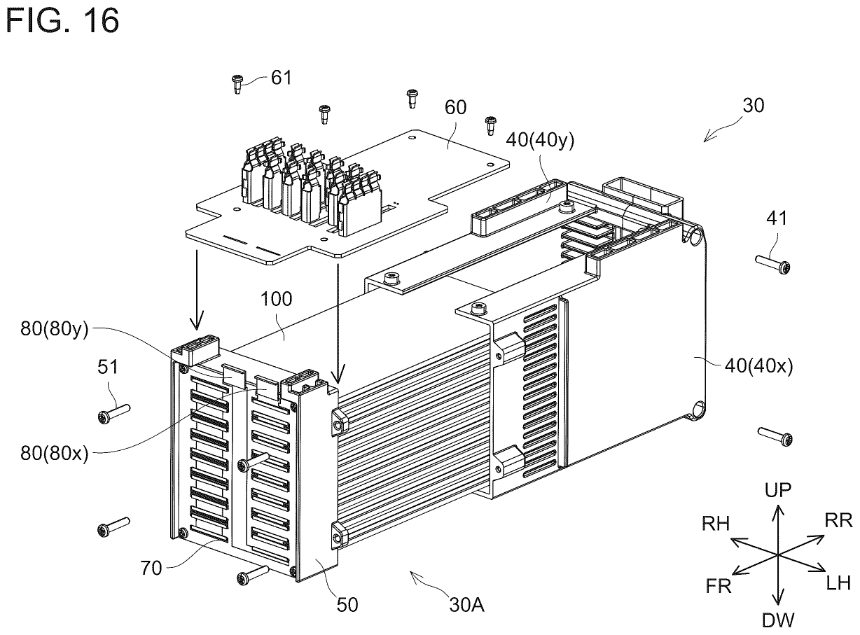

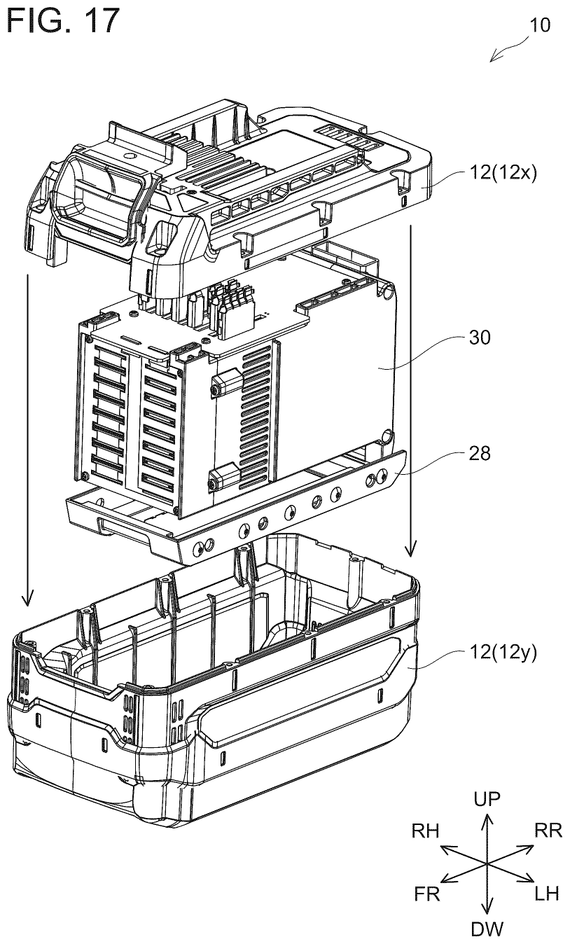

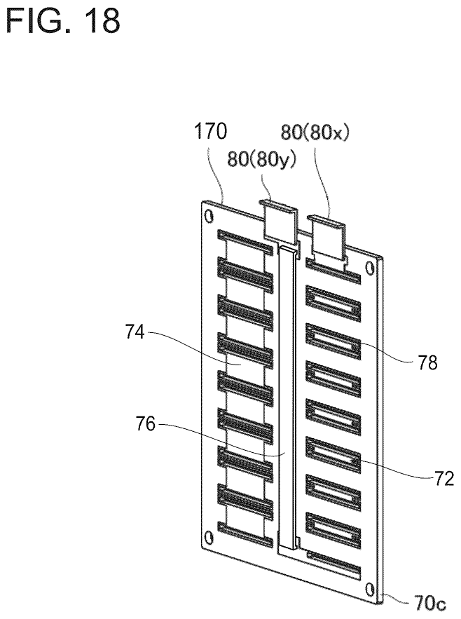

Next, as shown in FIG. 16, the cell holder 40 and the main board 60 are assembled to the semi-manufactured component 30A to complete the cell unit 30. Then, as shown in FIG. 17, the cell unit 30 is placed, together with the cushioning member 28, into the housing 12. The battery pack 10 is thus completed.

In the battery pack 10 of the present embodiment, the first conductor line 72, the second conductor line 74, and the third conductor line 76 on the sub board 70 are formed of conductor films (specifically, copper films) formed on the surface of the sub board 70. However, the first conductor line 72, the second conductor line 74, and the third conductor line 76 may be formed of other conductor members such as conductor plates or conductor cables. As an example, FIG. 18 shows a modification of a sub board 170. On this sub board 170, at least a portion of the third conductor line 76 is formed of a conductor plate attached to the sub board 170. A conductor plate of this type is also referred to as a bus bar and has a larger cross-sectional area than conductor films. Thus, by at least a portion of the first conductor line 72, the second conductor line 74, and the third conductor line 76 being formed of a conductor plate such as a bus bar, the electric resistance of the sub board 170 can be reduced.

Hereinafter, preferred embodiments of a battery pack for power tool understood from the battery pack 10 of the above-described embodiment will be listed.

[Embodiment 1-1] A battery pack comprising: a plurality of pouch battery cells stacked along a first direction, wherein each of the pouch battery cells comprises a positive electrode tab and a negative electrode tab that protrude in a second direction perpendicular to the first direction; a main board located in the first direction relative to the plurality of pouch battery cells and comprising a power port for electrical connection to an external device; a sub board located in the second direction relative to the plurality of pouch battery cells and connected to the positive electrode tabs and the negative electrode tabs of the plurality of pouch battery cells, and a connection member electrically connecting the sub board to the main board.

[Embodiment 1-2] The battery pack according to Embodiment 1-1, wherein the connection member comprises at least one lead plate.

[Embodiment 1-3] The battery pack according to Embodiment 1-2, wherein the main board intersects a straight line extending from the sub board in the first direction, and the lead plate extends parallel to the first direction between the sub board and the main board.

[Embodiment 1-4] The battery pack according to Embodiment 1-2, wherein the main board does not intersect a straight line extending from the sub board in the first direction, and the lead plate extends at an angle to the first direction between the sub board and the main board.

[Embodiment 1-5] The battery pack according to any one of Embodiment 1-1 to 1-4, further comprising a cell holder holding the plurality of pouch battery cells.

[Embodiment 1-6] The battery pack according to Embodiment 1-5, wherein the cell holder comprises an inner surface facing the plurality of pouch battery cells, and the inner surface of the cell holder comprises a plurality of ribs respectively supporting the plurality of pouch battery cells.

[Embodiment 1-7] The battery pack according to Embodiment 1-6, wherein the plurality of ribs is located in an opposite direction to the second direction relative to the plurality of pouch battery cells.

[Embodiment 1-8] The battery pack according to Embodiment 1-6 or 1-7, further comprising: a housing accommodating the cell holder, and a cushioning member located between the cell holder and the housing.

[Embodiment 1-9] The battery pack according to any one of Embodiments 1-5 to 1-8, wherein the main board is attached to the cell holder.

[Embodiment 1-10] The battery pack according to any one of Embodiments 1-5 to 1-9, wherein the sub board is attached to the cell holder.

[Embodiment 1-11] The battery pack according to Embodiment 1-10, wherein the sub board is attached to the cell holder via a frame, and the frame covers at least a portion of a periphery of the sub board.

[Embodiment 1-12] The battery pack according to Embodiment 1-11, wherein the frame comprises an inner surface facing the plurality of pouch battery cells, and the inner surface of the frame comprises a plurality of ribs respectively supporting the plurality of pouch battery cells.

[Embodiment 1-13] The battery pack according to Embodiment 1-12, wherein the frame is removably attached to the cell holder.

[Embodiment 1-14] The battery pack according to any one of Embodiment 1-1 to 1-13, wherein the sub board comprises circuitry that electrically connects the plurality of pouch battery cells.

[Embodiment 1-15] The battery pack according to any one of Embodiment 1-1 to 1-14, wherein the circuitry electrically connects the plurality of pouch battery cells in series.

[Embodiment 1-16] The battery pack according to Embodiment 1-15, wherein the plurality of pouch battery cells is stacked such that orientations of front and back sides of the pouch battery cells are reversed alternately, and in each pair of two adjacent pouch battery cells, the positive electrode tab of one pouch battery cell is adjacent to the negative electrode tab of other pouch battery cell along the first direction.

[Embodiment 1-17] The battery pack according to Embodiment 1-16, wherein the circuitry of the sub board comprises a first conductor line extending intermittently along the first direction and a second conductor line extending intermittently and parallel to the first conductor line, and in each of the plurality of pouch battery cells, one of the positive tab and the negative tab is connected to the first conductor line and other of the positive tab and the negative tab is connected to the second conductor line.

[Embodiment 1-18] The battery pack according to Embodiment 1-17, wherein the circuitry of the sub board further comprises a third conductor line extending between the first conductor line and the second conductor line along the first direction, and one of the first conductor line and the second conductor line is connected to the connection member via the third conductor line.

[Embodiment 19] The battery pack according to Embodiment 1-14, wherein the third conductor line electrically connects between the negative electrode tab of one of the plurality of pouch battery cells that is located farthest from the main substrate and the connection member.

[Embodiment 1-20] The battery pack according to any one of Embodiments 1-1 to 1-19, wherein the power port comprises a contact-type external connection terminal constituted of a conductive material.

[Embodiment 2-1] A battery pack comprising: a plurality of pouch battery cells stacked along a first direction, wherein each of the pouch battery cells comprises a positive electrode tab and a negative electrode tab that protrude in a second direction perpendicular to the first direction; a board located in the second direction relative to the plurality of pouch battery cells and connected to the positive electrode tabs and the negative electrode tabs of the plurality of pouch battery cells; a frame to which the board is attached, wherein the frame extends around the plurality of pouch battery cells along the board; a sealant filling an area surrounded by the frame, wherein the positive electrode tabs and the negative electrode tabs extending from the plurality of pouch battery cells to the board are enclosed in the sealant; and a housing accommodating the plurality of pouch battery cells, the board, and the frame.

[Embodiment 2-2] The battery pack according to Embodiment 2-1, wherein the sealant is constituted of a potting material or a photocurable material.

[Embodiment 2-3] The battery pack according to Embodiment 2-1 or 2-2, wherein the frame comprises a frame surface that contacts the board and extends along a periphery of the board.

[Embodiment 2-4] The battery pack according to any one of Embodiments 2-1 to 2-3, wherein a sheet material that is more flexible than the frame and the board is interposed between the frame surface of the frame and the board.

[Embodiment 2-5] The battery pack according to any one of Embodiments 2-1 to 2-4, wherein the frame comprises an inner surface facing the plurality of pouch battery cells, and the inner surface of the frame comprises a plurality of ribs respectively supporting the plurality of pouch battery cells.

[Embodiment 2-6] The battery pack according to Embodiment 2-5, wherein each of the plurality of ribs is spaced apart from the board.

[Embodiment 2-7] The battery pack according to Embodiment 2-5 or 2-6, wherein each of the plurality of ribs comprises a notch located within the sealant.

[Embodiment 2-8] The battery pack according to any one of Embodiments 2-5 to 2-7, wherein the frame comprises a projection between each pair of adjacent ribs, and each projection supports corresponding one of the plurality of pouch battery cells in the second direction.

[Embodiment 2-9] The battery pack according to any one of Embodiments 2-1 to 2-8, wherein the board comprises a plurality of tab connection holes, and in each of the plurality of tab connection holes, the positive electrode tab or the negative electrode tab of a corresponding one of the plurality of pouch battery cells is inserted.

[Embodiment 2-10] The battery pack according to Embodiment 2-9, wherein the board comprises a first surface facing the plurality of pouch battery cells and a second surface opposite to the first surface, and the positive electrode tabs and the negative electrode tabs of the plurality of pouch battery cells are each joined to the board on the second surface.

[Embodiment 2-11] The battery pack according to Embodiment 2-10, wherein on the second surface of the board, the positive electrode tabs and the negative electrode tabs of the plurality of pouch battery cells are covered by an adhesive.

[Embodiment 2-12] The battery pack according to any one of Embodiments 2-1 to 2-11, further comprising a cell holder located within the housing and holding the plurality of pouch battery cells, wherein the frame is attached to the cell holder.

[Embodiment 2-13] A manufacturing method for a battery cell, comprising: preparing a semi-manufactured component that comprises a plurality of pouch battery cells stacked along a first direction, wherein each of the pouch battery cells comprises a positive electrode tab and a negative electrode tab that protrude in a second direction perpendicular to the first direction; a board located in the second direction relative to the plurality of pouch battery cells and connected to the positive electrode tabs and the negative electrode tabs of the plurality of pouch battery cells; and a frame to which the board is attached, wherein the frame extends around the plurality of pouch battery cells along the board; orienting the semi-manufactured component such that an area surrounded by the frame is positioned above the board to fill the area surrounded by the frame with a mobile material; forming a sealant body that encloses the positive electrode tabs and the negative electrode tabs extending from the plurality of pouch battery cells to the board by curing the material; and placing the plurality of pouch battery cells, the board, and the frame, together with the sealant body, into a housing.

[Embodiment 2-14] The manufacturing method according to Embodiments 2-13, wherein the preparing a semi-manufactured component comprises inserting the positive electrode tabs and the negative electrode tabs of the plurality of pouch battery cells into a plurality of tab connection holes defined in the board such that in each of the plurality of tab connection holes, the positive electrode tab or the negative electrode tab of a corresponding one of the plurality of pouch battery cells is inserted.

[Embodiment 2-15] The manufacturing method according to Embodiments 2-14, wherein the board comprises a first surface facing the plurality of pouch battery cells and a second surface opposite to the first surface, and the preparing a semi-manufactured component further comprises joining the positive electrode tabs and the negative electrode tabs of the plurality of pouch battery cells inserted in the plurality of tab connection holes to the second surface.

[Embodiment 3-1] A battery pack comprising: a plurality of pouch battery cells stacked along a first direction; an inner housing that accommodates the plurality of pouch battery cells and comprises an inner inlet and an inner outlet; and a housing that accommodates the inner housing and comprises an inlet and an outlet, wherein the inner inlet is located in a second direction perpendicular to the first direction relative to the inner outlet, and the inlet is located in the second direction relative to the outlet.

[Embodiment 3-2] The battery pack according to Embodiment 3-1, wherein the inner outlet is connected to the outlet substantially in an air tight manner or is located within the outlet.

[Embodiment 3-3] The battery pack according to Embodiment 3-2, wherein the inner outlet and the outlet are located in an opposite direction to the second direction relative to the plurality of pouch battery cells.

[Embodiment 3-4] The battery pack according to Embodiment 3-2 or 3-3, wherein the inlet is located in the second direction relative to the inner inlet.

[Embodiment 3-5] The battery pack according to Embodiment 3-4, wherein the inlet is located in the second direction relative to the plurality of pouch battery cells.

[Embodiment 3-6] The battery pack according to any one of Embodiments 3-2 to 3-5, wherein the housing comprises an inner side wall that faces the plurality of pouch battery cells in a third direction perpendicular to the first direction and the second direction, and the inner inlet is defined in the inner side wall.

[Embodiment 3-7] The battery pack according to Embodiment 3-6, wherein the inner inlet comprises a plurality of through holes defined in the inner side wall, and the plurality of through holes is arranged along the first direction and each of the through holes is elongated along the second direction.

[Embodiment 3-8] The battery pack according to Embodiment 3-6 or 3-7, wherein one of the inner side wall of the inner housing and a side wall of the housing facing the inner side wall comprises a flow guide wall projecting toward other of the inner side wall of the inner housing and the side wall of the housing, and the inner inlet is located in the second direction relative to the flow guide wall.

[Embodiment 3-9] The battery pack according to any one of Embodiments 3-1 to 3-8, wherein the inner housing comprises a cell holder holding the plurality of battery cells and at least one board attached to the cell holder, and the at least one board comprises circuitry electrically connected to the plurality of pouch battery cells.

[Embodiment 3-10] The battery pack according to Embodiment 3-9, wherein the at least one board comprises a main board, and the main board is located in the first direction relative to the plurality of pouch battery cells and comprises a power port for electrical connection to an external device.

[Embodiment 3-11] The battery pack according to Embodiment 3-9 or 3-10, wherein the at least one board comprises a sub board, and the sub board is located in the second direction relative to the plurality of pouch battery cells and is connected to positive electrode tabs and negative electrode tabs of the plurality of pouch battery cells.

[Embodiment 3-12] The battery pack according to Embodiment 3-11, wherein the inlet is located in the second direction relative to the sub board.

[Embodiment 3-13] The battery pack according to Embodiment 3-1, wherein the inner inlet is connected to the inlet substantially in an air tight manner or is located within the inlet.

[Embodiment 3-14] The battery pack according to Embodiment 3-13, wherein the inner inlet and the inlet are located in the second direction relative to the plurality of pouch battery cells.

[Embodiment 3-15] The battery pack according to Embodiment 3-13 or 3-14, wherein the outlet is located in the second direction relative to the inner outlet.

[Embodiment 3-16] The battery pack according to Embodiment 3-15, wherein the outlet is located in an opposite direction to the second direction relative to the plurality of pouch battery cells.

[Embodiment 3-17] The battery pack according to any one of Embodiments 3-13 to 3-16, wherein the inner housing comprises an inner side wall that faces the plurality of pouch battery cells in a third direction perpendicular to the first direction and the second direction, and the inner outlet is defined in the inner side wall.

[Embodiment 3-18] The battery pack according to Embodiments 3-17, wherein the inner outlet comprises a plurality of through holes defined in the inner side wall, and the plurality of through holes is arranged along the first direction and each of the through holes is elongated along the second direction.

[Embodiment 3-19] The battery pack according to any one of Embodiments 3-1 to 3-18, wherein at least one of the inlet and the outlet is connected to a fan of an external device.

### REFERENCE SIGNS LIST

10: Battery Pack
12: Housing
14: Inlet
16: Outlet
26: Power Port
28: Cushioning Member
30: Cell Unit
32: Inner Housing
34: Inner Inlet
36: Inner Outlet
38: Flow Guide Wall
40: Cell Holder
50: Frame
54: Rib of Frame
55: Projection of Frame
56: Frame Surface of Frame
58: Rim of Frame
60: Main Board
70, 170: Sub Board
72: First Conductor Line
74: Second Conductor Line
76: Third Conductor Line
78: Tab Connection Hole
80: Connection Member
80x: Positive Electrode Lead Plate
80y: Negative Electrode Lead Plate
90: Sealant
92: Adhesive

1. A battery pack comprising:
a plurality of pouch battery cells stacked along a first direction, wherein each of the pouch battery cells comprises a positive electrode tab and a negative electrode tab that protrude in a second direction perpendicular to the first direction;
a main board located in the first direction relative to the plurality of pouch battery cells and comprising a power port for electrical connection to an external device;
a sub board located in the second direction relative to the plurality of pouch battery cells and connected to the positive electrode tabs and the negative electrode tabs of the plurality of pouch battery cells; and
a connection member electrically connecting the sub board to the main board.

2. The battery pack according to claim 1, wherein the connection member comprises at least one lead plate.

3. The battery pack according to claim 2, wherein
the main board intersects a straight line extending from the sub board in the first direction, and
the at least one lead plate extends parallel to the first direction between the sub board and the main board.

4. The battery pack according to claim 2, wherein
the main board does not intersect a straight line extending from the sub board in the first direction, and
the at least one lead plate extends at an angle to the first direction between the sub board and the main board.

5. The battery pack according to claim 1, further comprising a cell holder holding the plurality of pouch battery cells.

6. The battery pack according to claim 5, wherein
the cell holder comprises an inner surface facing the plurality of pouch battery cells, and
the inner surface of the cell holder comprises a plurality of ribs respectively supporting the plurality of pouch battery cells.

7. The battery pack according to claim 6, wherein the plurality of ribs is located in an opposite direction to the second direction relative to the plurality of pouch battery cells.

8. The battery pack according to claim 6, further comprising:
a housing accommodating the cell holder, and
a cushioning member located between the cell holder and the housing.

9. The battery pack according to claim 5, wherein the main board is attached to the cell holder.

10. The battery pack according to claim 5, wherein the sub board is attached to the cell holder.

11. The battery pack according to claim 10, wherein
the sub board is attached to the cell holder via a frame, and
the frame covers at least a portion of a periphery of the sub board.

12. The battery pack according to claim 11, wherein
the frame comprises an inner surface facing the plurality of pouch battery cells, and
the inner surface of the frame comprises a plurality of ribs respectively supporting the plurality of pouch battery cells.

13. The battery pack according to claim 12, wherein the frame is removably attached to the cell holder.

14. The battery pack according to claim 1, wherein the sub board comprises circuitry that electrically connects the plurality of pouch battery cells.

15. The battery pack according to claim 14, wherein the circuitry electrically connects the plurality of pouch battery cells in series.

16. The battery pack according to claim 15, wherein
the plurality of pouch battery cells is stacked such that orientations of front and back sides of the pouch battery cells are reversed alternately, and
in each pair of two adjacent pouch battery cells, the positive electrode tab of one pouch battery cell is adjacent to the negative electrode tab of the other pouch battery cell along the first direction.

17. The battery pack according to claim 16, wherein
the circuitry of the sub board comprises a first conductor line extending intermittently along the first direction and a second conductor line extending intermittently and parallel to the first conductor line, and
in each of the plurality of pouch battery cells, one of the positive electrode tab and the negative electrode tab is connected to the first conductor line and the other of the positive electrode tab and the negative electrode tab is connected to the second conductor line.

18. The battery pack according to claim 17, wherein
the circuitry of the sub board further comprises a third conductor line extending between the first conductor line and the second conductor line along the first direction, and
one of the first conductor line and the second conductor line is connected to the connection member via the third conductor line.

19. The battery pack according to claim 18, wherein
the third conductor line electrically connects between the negative electrode tab of one of the plurality of pouch battery cells that is located farthest from the main substrate and the connection member.

20. The battery pack according to claim 1, wherein the power port comprises a contact-type external connection terminal constituted of a conductive material.
